(19) United States
(12) Patent Application Publication
(10) Pub. No.: US 2018/0267780 A1
(43) Pub. Date: Sep. 20, 2018

(54) METHODS FOR PROVIDING CONDITIONAL ALLOCATION OF BUILD FILES AND RELATED SYSTEMS AND COMPUTER PROGRAM PRODUCTS

(71) Applicant: CA, Inc., New York, NY (US)

(72) Inventors: Arthur V. Richards, Natick, MA (US); Jonathan H. Thomson, Slatersville, RI (US)

(73) Assignee: CA, Inc., New York, NY (US)

(21) Appl. No.: 15/461,584

(22) Filed: Mar. 17, 2017

(51) Int. Cl. G06F 9/44; G06F 9/45; G06F 9/445

(52) U.S. Cl. CPC G06F 8/35; G06F 8/54; G06F 8/41

(57) ABSTRACT

A method may provide a robust build process for building a software application. The method may include providing a data definition corresponding to a software application build process, the data definition including identities of multiple computing data resources in a build script that, when executed, performs a series of operations that use ones of the computing data resources to build the software application. The method may include designating, in the build script, at least one of the computing data resources in the build script that is a conditionally allocated computing data resource and executing the build script by performing the series of operations that are identified therein using corresponding ones of the plurality of computing data resources that are identified in the data definition. Related systems and computer program products are also discussed.

### TECHNICAL FIELD

The present disclosure relates to application framework development and more particularly, to providing conditional allocation of build files and related methods, systems and computer program products.

### BACKGROUND

An application framework consists of a software framework that may be used by software developers to implements a structure corresponding to an application. Within this application framework, software developers may use a software build process that may include a compilation process in which multiple source code and/or data files are converted into executable code. The software build process may be an automated build process that may include compiling computer source code into binary code, packaging binary code and running automated tests.

An automated build process may be accomplished using a build tool, such as an automation utility, that may calculate how to reach the build goal by executing tasks in the correct order and running each task. In a typical build process, resources such as headers, macros, copybooks, objects, etc. may be required for the build process to succeed. In some cases, the required resources are contained in a hierarchy of files that must be searched according to the development lifecycle, which requires that all possible files to be searched must exist for the process to succeed, even if some of those files are empty. The creation of empty files for the build process to succeed may result in the consumption of unnecessary time, effort, and/or computer resources, such as storage.

In the event that one or more of the requisite files are not present during the build process, the build process may stall and/or terminate prematurely. In some instances, the stall and/or premature termination may also be coupled with an error message. Accordingly, there continues to exist a need in the art for improving software build processes.

### SUMMARY

Some embodiments of the present disclosure are directed to methods for providing robust build process for building a software application. Such methods may include providing a data definition corresponding to a software application build process. The data definition including identities of multiple computing data resources in a build script. When the computing data resources are executed, a series of operations that use the computing data resources to build the software application are performed. Some embodiments provide that the computing data resources include header files, macros, copybooks and/or objects.

Methods may include designating, in the build script, at least one of the computing data resources in the build script as a conditionally allocated computing data resource and executing the build script by performing the series of operations using corresponding ones of the computing data resources that are identified in the data definition. Some embodiments provide that, responsive to the conditionally allocated resource being unavailable, the build script continues to perform other ones of the series of operations using other ones of the computing data resources.

In some embodiments, the conditionally allocated resource that is unavailable does not exist and/or does not include a correct path identifying a location thereof.

Some embodiments provide that designating at least one of the computing data resources as the conditionally allocated computing data resource comprises including an allocation parameter in the data definition and that corresponds to the conditionally allocated computing data resource. In some embodiments, a first value of the allocation parameter corresponds to the at least one of the plurality of computing data resources being designated as the conditionally allocated computing data resource. Some embodiments provide that, responsive to the at least one of the computing data resources having the allocation parameter at the first value during executing the build script and the corresponding computing data resources being available, the build script performs the operation corresponding to the at least one of the computing data resources having the allocation parameter at the first value and additional ones of the series of operations.

In some embodiments, responsive to the at least one of the computing data resources having the allocation parameter at the first value during executing the build script and the at least one of the computing data resources being unavailable, the build script performs the additional ones of the series of operations without performing an operation corresponding to the at least one of the computing data resources having the allocation parameter at the first value.

Some embodiments provide that a second value of the allocation parameter corresponds to ones of the computing data resources that are required for the build script to continue with other ones of the series of operations. In some embodiments, responsive to one of the computing data resources having the allocation parameter at the second value and the one of the computing data resources not being available during executing the build script, the build script ceases to perform any additional ones of the series of operations. In some embodiments, responsive to one of the computing data resources having the allocation parameter at the second value and the one of the computing data resources not being available during executing the build script, further comprising generating an error message.

In some embodiments, executing the build script includes converting multiple source code files into a software file that is the software application by compiling and/or linking ones of the computing data resources in a given order.

Some embodiments of the present disclosure are directed to an automated software build system that includes a processor and a memory coupled to the processor and including computer readable program code that when executed by the processor causes the processor to perform certain operations. Operations may include providing a data definition corresponding to a software application build process. The data definition may include identities of computing data resources in a build script that, when executed, performs a series of operations that use the computing data resources to build the software application. Operations may include designating, in the build script, at least one of the computing data resources in the build script that is a conditionally allocated computing data resource. Some embodiments provide that, responsive to the conditionally allocated resource being unavailable, the build script continues to perform other ones of the series of operations using other ones of the computing resources.

In some embodiments, designating the at least one of the computing data resources as the conditionally allocated computing data resource comprises including an allocation parameter in the data definition that corresponds to the conditionally allocated computing data resource.

Some embodiments provide a first value of the allocation parameter corresponds to the at least one of the plurality of computing data resources being designated as a conditionally allocated computing data resource and a second value of the allocation parameter corresponds to computing data resources that are required for the build script to continue with other ones of the series of operations.

In some embodiments, responsive to the at least one of the computing data resources having the first value of the allocation parameter during executing the build script, the build script performs additional ones of the series of operations.

Some embodiments provide that, responsive to one of the computing data resources having the second value of the allocation parameter during executing the build script, the build script ceases to perform any additional ones of the series of operations if the one of the computing data resources is not available.

In some embodiments, responsive to one of the plurality of computing data resources being provided in the data definition without the allocation parameter, the build script ceases to perform any additional ones of the series of operations if the one of the computing data resources is not available. Some embodiments further include, responsive to the build script ceasing to perform any additional ones of the series of operations, generating an error message that corresponds to the one of the computing data resources that is unavailable.

Some embodiments include executing the build script by converting multiple source code files into a software file by compiling and/or linking ones of the computing data resources in a given order.

Some embodiments of the present disclosure are directed to a computer program product including a non-transitory computer readable storage medium storing computer readable program code which when executed by a processor of an electronic device causes the processor to perform certain operations. Examples of such operations include providing a data definition corresponding to a software application build process. The data definition may include identities of multiple computing data resources in a build script that, when executed, perform a series of operations that use the computing data resources to build the software application. Operations may include designating, in the build script, at least one of the computing data resources in the build script that is a conditionally allocated computing data resource and executing the build script by performing the series of operations that are identified therein using corresponding ones of the computing data resources that are identified in the data definition,

In some embodiments, responsive to the conditionally allocated resource being unavailable, the build script continues to perform other ones of the series of operations using other ones of the plurality of computing resources.

It is noted that aspects of the present disclosure described with respect to one embodiment, may be incorporated in a different embodiment although not specifically described relative thereto. That is, all embodiments and/or features of any embodiment can be combined in any way and/or combination. These and other objects and/or aspects of the present disclosure are explained in detail in the specification set forth below.

### BRIEF DESCRIPTION OF THE DRAWINGS

The accompanying figures are included to provide a further understanding of the present disclosure, and are incorporated in and constitute a part of this specification. The drawings illustrate some embodiments of the present disclosure and, together with the description, serve to explain principles of the present disclosure.

FIG. 1 is a flow chart illustrating operations in the execution of a build process according to some embodiments of the present disclosure.

FIG. 2 is a block diagram illustrating a software development environment according to some embodiments of the present disclosure.

FIG. 3 is a screen shot illustrating an example of a data definition summary that includes identifications of multiple computer data resources and types thereof according to some embodiments of the present disclosure.

FIG. 4 is a flow chart illustrating operations according to some embodiments of the present disclosure.

FIG. 5 is a block diagram illustrating an arrangement of network devices/elements according to some embodiments of the present disclosure.

FIG. 6 is a block diagram illustrating a data processing system for program development according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that embodiments of present inventive concepts may be practiced without these specific details. In other instances, well-known methods, procedures, components and circuits have not been described in detail so as not to obscure present inventive concepts. It is intended that all embodiments disclosed herein can be implemented separately or combined in any way and/or combination.

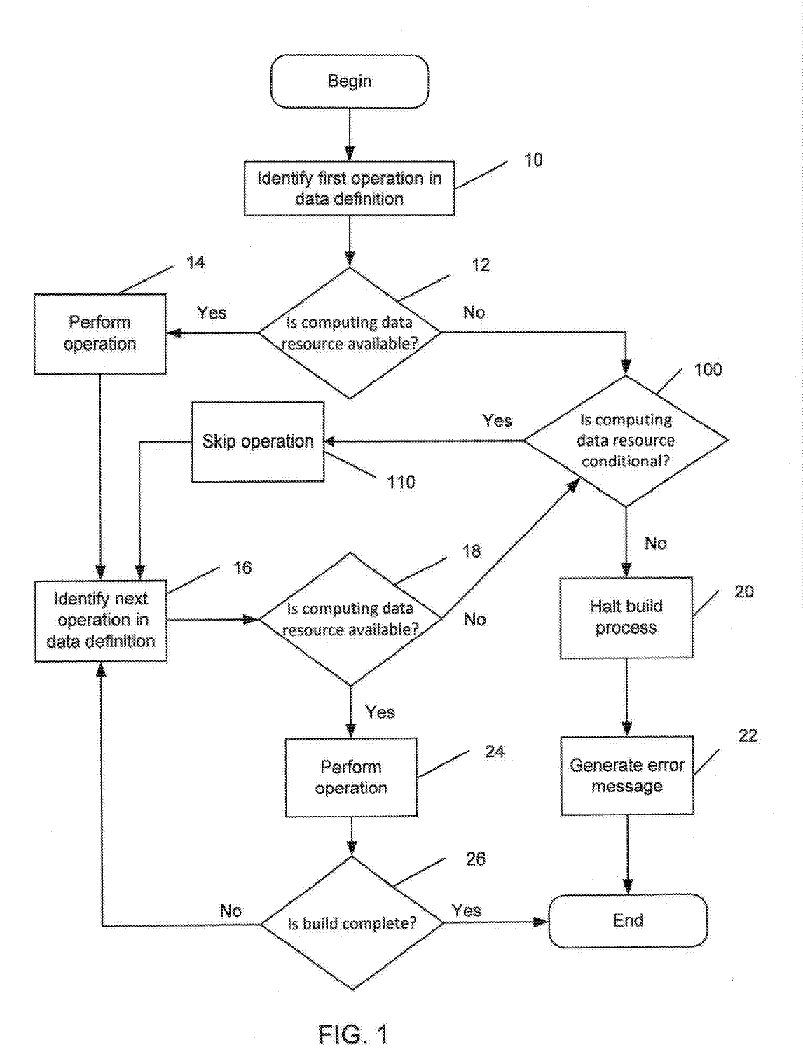

Reference is now made to FIG. 1, which is a flow chart illustrating operations in the execution of a build process according to some embodiments of the present disclosure. A build process may include a data definition corresponding to the software application build process. The data definition may identify a series of operations that may be sequentially performed using multiple computing data resources. Examples of computing data resources include but are not limited to data files such as header files, macros, copy books and/or objects, among others. Executing the build process according to embodiments herein begins with identifying a first operation in the data definition (block 10). The first operation identified in the data definition may be associated with a given computing data resource.

A determination may be made as to whether the computing data resource is available (block 12). If the computing data resource is available, then the corresponding operation may be performed (block 14). Once the operation is performed, the next operation in the data definition may be identified (block 16). If the computing data resource is not available, then the determination may be made as to whether the computing data resource is conditionally allocated (e.g., conditional) (block 100). Some embodiments provide that a computing data resource may not be available if the computing data resource does not exist, if a path to the computing data resource is incomplete and/or incorrect, among others. In some embodiments, the computing data resource may be conditionally allocated using an allocation parameter in the data definition. For example, allocation parameter such as ALLOC=COND may be provided in association with the conditionally allocated computing data resource in the data definition.

If the non-available computing data resource is conditionally allocated, then the operation may be skipped without generating an error or halting the build process (block 110) and the next operation in the data definition may be identified (block 16). If the non-available computing data resource is not conditionally allocated, then the build process may be halted (block 20). In this manner, an unavailable resource that is not conditionally allocated may result in the build process not completing. In some embodiments, optionally, an error message may be generated (block 22) as a result of the build process being halted.

Although illustrated in the context of a build process of a software application, embodiments herein may be applied to any batch processing operation that identifies a series of operations to be performed in a sequential manner. For example, a batch file that identifies multiple sequential operations may benefit from having individual ones of the resources used thereby being conditionally allocated in the context of the present disclosure. By providing a completion option for a build process or other batch processing operations even in the absence of specific computing data resources that may be conditionally allocated, an efficiency in processing and/or computer operations may be realized by not halting a process to generate errors regarding non-essential potions thereof.

After identifying the next operation in the data definition (block 16), a determination may be made as to whether the corresponding computing data resource is available (block 18). If the computing data resource is not available, then the determination may be made as to whether the computing data resource is conditionally allocated (e.g., conditional) (block 100). Based on the outcome of this determination, the build process may be halted or continue to process subsequent operations as discussed above.

If the computing data resource is available, then the corresponding operation may be performed (block 24). Once the operation is performed, a determination may be made as to whether the build process is complete (block 26). If the build process is complete, then the build process may end. If the build process is not complete, the next operation in the data definition may be identified (block 16). Once the operation is performed, the operations discussed above may continue until the process is completed or halted.

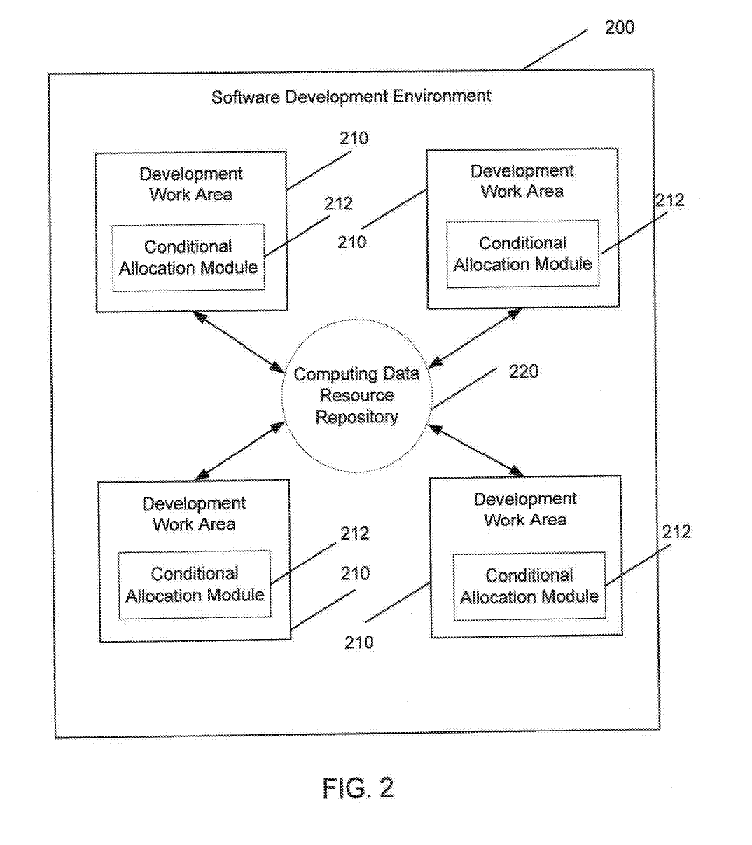

Brief reference is now made to FIG. 2, which is a block diagram illustrating a software development environment according to some embodiments of the present disclosure. A software development environment 200 may include multiple development work areas 210 that may be physically and/or logically distinct from one another. Individual ones of the development work areas 210 may be designated for individual and/or teams of developers. The development work areas 210 may include computing data resources that may be specific to the development tasks occurring therein. One or more of the development work areas 210 may include a conditional allocation module 212 that may provide for the conditional allocation of one or more computing data resources.

Some embodiments provide that a computing data resource repository 220 may provide a common repository for computing data resources that may be used by software developers corresponding to the different development work areas 210. The computing data resource repository 220 may include one or more physical and/or virtual servers and/or data storage devices that may be physically and/or logically distinct from the development work areas.

In some instances, software developers operating within one of the development work areas 210 may generate a build process having a data definition (also referred to as a data definition summary) that identifies computing data resources that are in the computing data resource repository 220 and that have been modified, removed and/or otherwise made not available by one of the other developers. In this regard, if the computing data resource is not available and the data definition identifies the computing data resource as conditionally allocated, the build process may not be halted prior to completion based on the modified, removed and/or otherwise non available computing data resource.

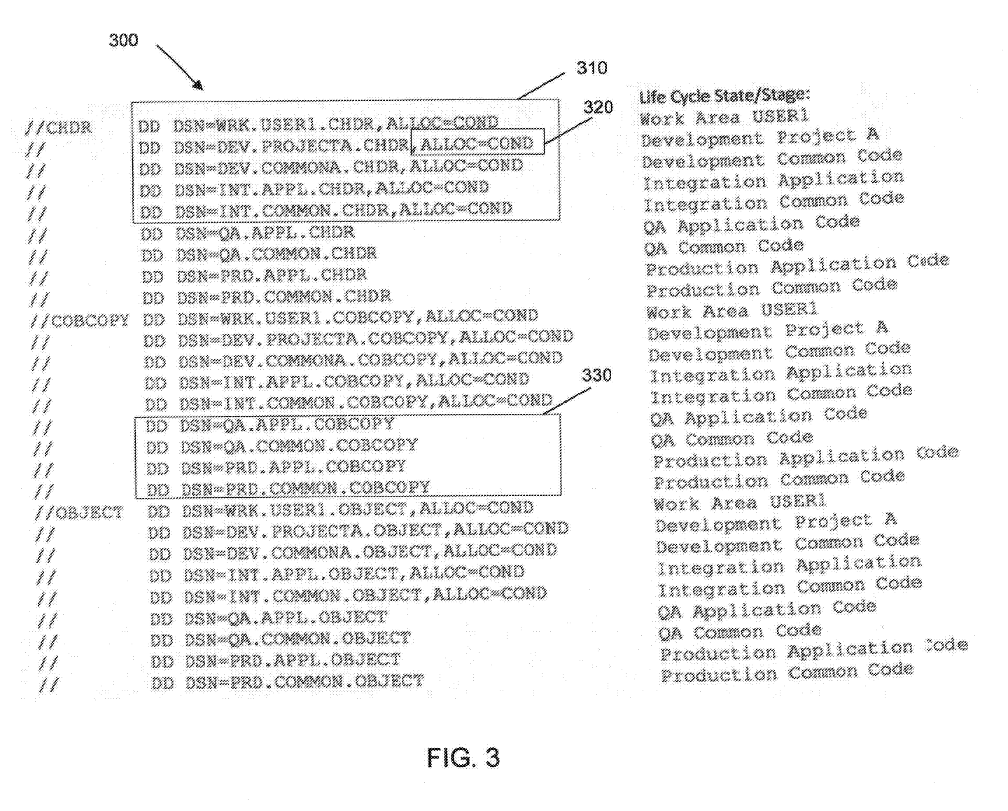

Reference is now made to FIG. 3, which is a screen shot illustrating an example of a data definition summary 300 that includes identifications of multiple computer data resources and types thereof according to some embodiments of the present disclosure. The data definition summary 300 includes a series of computer data resources that may be collectively used to perform a build process. Referring to block 310, some of the identifiers for the computer data resources include the indication that the computing data resources are conditionally allocated. For example, the identifiers within block 310 each includes the parameter ALLOC=COND (block 320), which is a parameter that indicates that the corresponding computer data resource is conditionally allocated. According to embodiments herein, if the computing data resources with the parameter ALLOC=COND are unavailable during the build process, the build process will continue without access to these unavailable computing data resources.

The data definition summary 300 also includes identifications of computing data resources that are not conditionally allocated as provided in block 330. In the event that any of these computing data resources is unavailable during the build process, the build process may be halted and an error message may be generated.

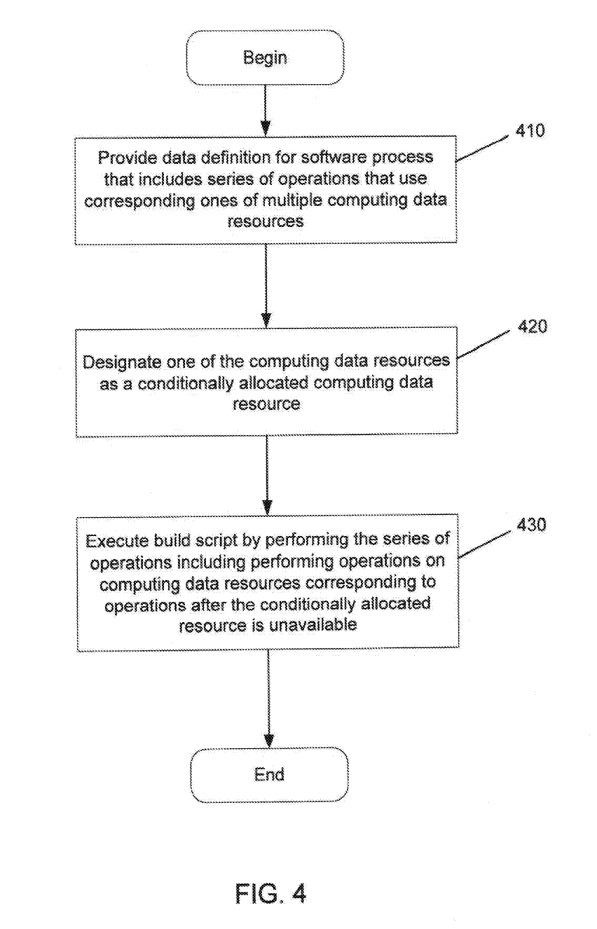

Reference is now made to FIG. 4, which is a flow chart illustrating operations according to some embodiments of the present disclosure. Operations include providing a data definition for a software application build process (block 410). The data definition, which may be represented as a data definition summary, may include the identities of computing data resources in a build script that perform a series of operations. Some embodiments provide that the order of the identities corresponds to a sequence of the operations for building the software application. The computing data resources may include header files, macros, copybooks and/or objects, among others.

Operations may include designating one or more of the computing data resources as a conditionally allocated computing data resource (block 420). Some embodiments provide that the computing data resources may be designated as a conditionally allocated computing data resource by including an allocation parameter for that computing data resource in the data definition. In some embodiments, the allocation parameter may be assigned multiple different values. For example, if the parameter “ALLOC” is assigned a value of “COND”, then the computing data resource may be designated as conditionally allocated.

The build script may be executed by performing the series of operations based on the data definition using the corresponding computing data resources that are identified in the data definition (block 430). In the event that a conditionally allocated computing data resource is unavailable, the build script may continue to perform other ones of the operations corresponding to remaining computing data resources. Some embodiments provide that a conditionally allocated resource may be determined to be unavailable if that resource does not exist, and/or if a logical path to a location for such resource is not available and/or is incorrect.

In the event that a computing data resource is conditionally allocated as evidenced by the allocation parameter having the value “COND” during the execution of the build script, if that computing data resource is available then the build script performs the operation corresponding to that computing data resource. Additionally, the build script continues to execute operations corresponding to the remaining computing data resources that are listed later in the data definition summary. However, if the conditionally allocated computing data resource is unavailable, instead of halting the build process, the build script performs operations corresponding to the remaining computing data resources. Although discussed herein as a single one of the computing data resources being conditionally allocated, two or more of the computing data resources may be conditionally allocated. In some embodiments, an entire category and/or class of computing data resource may be designated as conditionally allocated for a given build process.

Some embodiments provide that the allocation parameter may be assigned a value other than the first value (e.g., “COND”). For example, a parameter value of “MSG” may cause the build script to generate an error message without halting the build process if the corresponding computing data resource is unavailable. In this manner, a developer may be informed that the computing data resource is unavailable without the build process halting. Some embodiments provide the allocation parameter may be assigned a value other than the first value (e.g., “COND”) that expressly indicates that the build process should halt if the corresponding computing data resource is unavailable.

In some embodiments, executing the build script may be performed by converting one or more source code files into a software file by compiling and/or linking the one or more computing data resources in a given order.

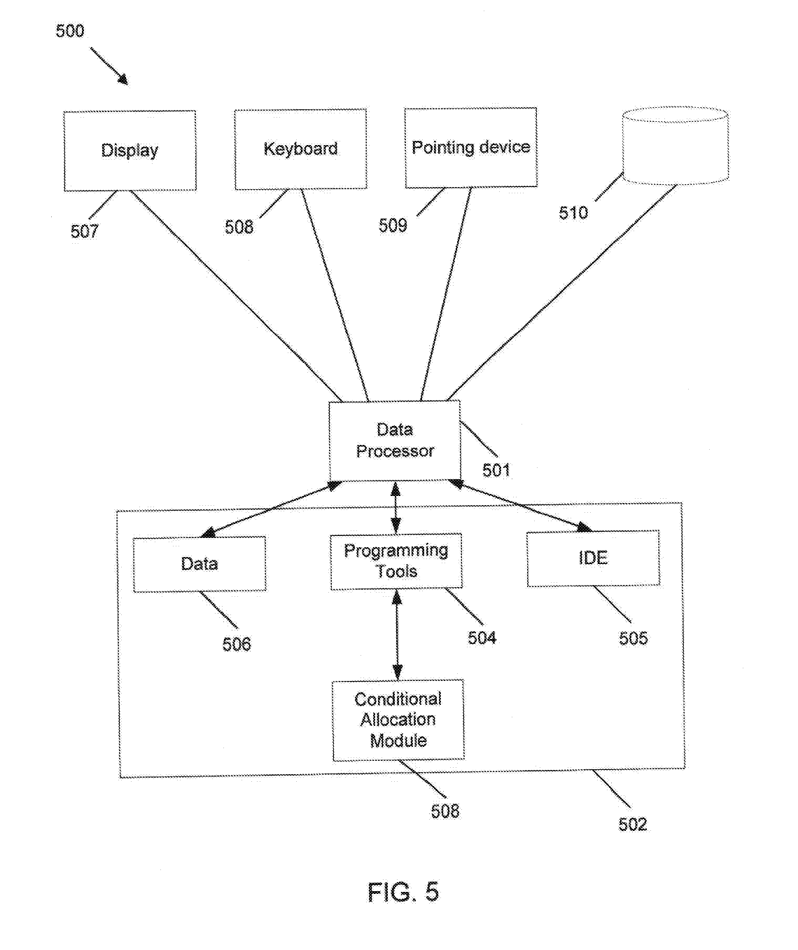

Reference is now made to FIG. 5, is a block diagram illustrating an arrangement of network devices/elements according to some embodiments of the present disclosure. In some embodiments, the data processing system 500 may include a data processor 501 and a memory 502. The memory 502 may be coupled to the data processor 501 via a data bus and may include program and data memory. The memory 502 may include program development tools 504, compilers, linkers, and library managers. Some embodiments provide the memory 502 includes an integrated program development environment (IDE) 505, which can invoke the program development tools 504. The memory 502 also contains data memory 506, specifically data and objects related to the execution of the program development tools 504 and the IDE 505.

Some embodiments provide that the memory may include a conditional allocation module 508 that may provide for the conditional allocation of computing data resources within a build script. As discussed herein, a build script may include conditionally allocated computing data resources that may be non-essential to the completion of the build script. For example, if a computing data resource is designated as conditionally allocated, then a build script may not halt execution if that conditionally allocated computing data resource is unavailable during the execution of the build script.

Some embodiments provide that the data processing system 500 may include a display 507 that is coupled to the data processor 501 and is configured to display information thereon. In some embodiments, a user data entry device 508 (e.g. keyboard or other interactive device), and a pointing device 509, for example, a mouse or a trackball, are also coupled to the data processor 501.

In some embodiments, the display 507 provides a presentation space for the IDE 505 in order to display the pieces of a program being constructed. In some embodiments, either the pointing device 509 or predefined keys of the data entry device 508 may be used to manipulate the data in conformity with aspects of the present disclosure.

Some embodiments include a persistent storage mechanism 510 may preferably exist and be utilized to store data and/or information. This type of storage media may include, but is not limited to, standard disk drive technology, tape, solid-state and/or semiconductor memory.

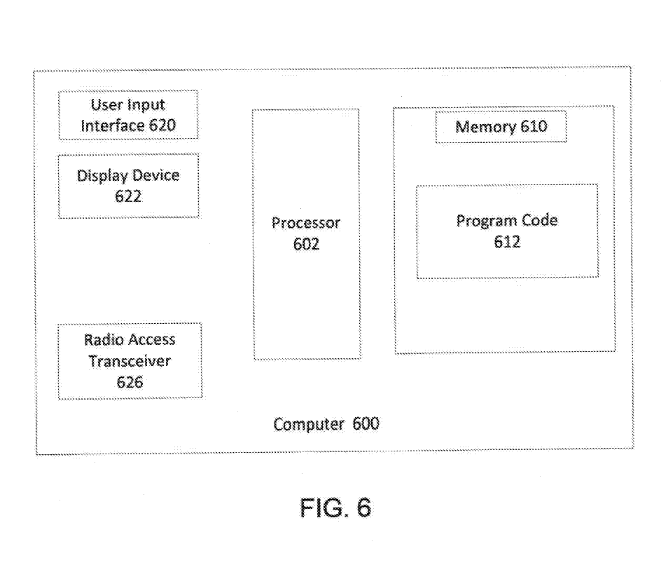

Reference is now made to FIG. 6, which is a block diagram illustrating a data processing system for program development according to some embodiments of the present disclosure. The data processing system may be a computer 600 includes a processor 602, a memory 610, and a network interface which may include a radio access transceiver 626 and/or a wired network interface 1024 (e.g., Ethernet interface). The radio access transceiver 626 can include, but is not limited to, a LTE or other cellular transceiver, WLAN transceiver (IEEE 802.11), WiMax transceiver, or other radio communication transceiver configured to communicate with a device and/or network via a radio access network.

The processor 602 may include one or more data processing circuits, such as a general purpose and/or special purpose processor (e.g., microprocessor and/or digital signal processor) that may be collocated or distributed across one or more networks. The processor 602 is configured to execute computer program code 612 in the memory 610, described below as a non-transitory computer readable medium, to perform at least some of the operations described herein as being performed by an application analysis computer. The computer 600 may further include a user input interface 620 (e.g., touch screen, keyboard, keypad, etc.) and a display device 622.

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of inventive concepts. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” (and the abbreviation “/”) includes any and all combinations of one or more of the associated listed items Like reference numbers signify like elements throughout the description of the figures.

It will be understood that, although the terms first, second, etc. may be used herein to describe various messages, operations, and/or components, these messages, operations, and/or components should not be limited by these terms. These terms are only used to distinguish one message, operation, and/or component from another message, operation, and/or component. Thus, a first message, operation, and/or component discussed herein could be termed a second message, operation, and/or component without departing from the teachings of the present disclosure.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of providing robust build process for building a software application, the method comprising:
providing a data definition corresponding to a software application build process, the data definition including identities of a plurality of computing data resources in a build script that, when executed, performs a series of operations that use ones of the plurality of computing data resources to build the software application;
designating, in the build script, at least one of the plurality of computing data resources in the build script that is a conditionally allocated computing data resource; and
executing the build script by performing the series of operations that are identified therein using corresponding ones of the plurality of computing data resources that are identified in the data definition,
wherein responsive to the conditionally allocated computing data resource being unavailable, the build script continuing to perform other ones of the series of operations using other ones of the plurality of computing data resources.

2. The method according to claim 1, wherein the conditionally allocated computing data resource that is unavailable does not exist and/or does not include a correct path identifying a location thereof.

3. The method according to claim 1, wherein designating the at least one of the plurality of computing data resources as the conditionally allocated computing data resource comprises including an allocation parameter in the data definition and that corresponds to the conditionally allocated computing data resource.

4. The method according to claim 3, wherein a first value of the allocation parameter corresponds to the at least one of the plurality of computing data resources being designated as the conditionally allocated computing data resource.

5. The method according to claim 4, wherein, responsive to the at least one of the plurality of computing data resources having the allocation parameter at the first value during executing the build script and the at least one of the plurality of computing data resources being available, the build script performs an operation of the series of operations corresponding to the at least one of the plurality of computing data resources having the allocation parameter at the first value and additional ones of the series of operations.

6. The method according to claim 4, wherein, responsive to the at least one of the plurality of computing data resources having the allocation parameter at the first value during executing the build script and the at least one of the plurality of computing data resources being unavailable, the build script performs additional ones of the series of operations without performing an operation corresponding to the at least one of the plurality of computing data resources having the allocation parameter at the first value.

7. The method according to claim 4, wherein a second value of the allocation parameter corresponds to ones of the plurality of computing data resources that are required for the build script to continue with other ones of the series of operations.

8. The method according to claim 7, wherein responsive to one of the plurality of computing data resources having the allocation parameter at the second value and the one of the plurality of computing data resources not being available during executing the build script, the build script ceases to perform any additional ones of the series of operations.

9. The method according to claim 7, wherein responsive to one of the plurality of computing data resources having the allocation parameter at the second value and the one of the plurality of computing data resources not being available during executing the build script, further comprising generating an error message.

10. The method according to claim 1, wherein executing the build script comprises converting a plurality of source code files into a software file that is the software application by compiling and/or linking ones of the plurality of computing data resources in a given order.

11. The method according to claim 1, wherein the plurality of computing data resources includes header files, macros, copybooks and/or objects.

12. An automated software build system comprising:
a processor; and
a memory coupled to the processor and comprising computer readable program code that when executed by the processor causes the processor to perform operations comprising,
providing a data definition corresponding to a software application build process for building a software application, the data definition including identities of a plurality of computing data resources in a build script that, when executed, performs a series of operations that use ones of the plurality of computing data resources to build the software application; and
designating, in the build script, at least one of the plurality of computing data resources in the build script that is a conditionally allocated computing data resource, wherein responsive to the conditionally allocated computing data resource being unavailable, the build script continues to perform other ones of the series of operations using other ones of the plurality of computing resources.

13. The automated software build system according to claim 12, wherein designating the at least one of the plurality of computing data resources as the conditionally allocated computing data resource comprises including an allocation parameter in the data definition and that corresponds to the conditionally allocated computing data resource.

14. The automated software build system according to claim 13, wherein a first value of the allocation parameter corresponds to the at least one of the plurality of computing data resources being designated as the conditionally allocated computing data resource, and
wherein a second value of the allocation parameter corresponds to ones of the plurality of computing data resources that are required for the build script to continue with other ones of the series of operations.

15. The automated software build system according to claim 14, wherein, responsive to the at least one of the plurality of computing data resources having the first value of the allocation parameter during executing the build script, the build script performs additional ones of the series of operations.

16. The automated software build system according to claim 14, wherein, responsive to one of the plurality of computing data resources having the second value of the allocation parameter during executing the build script, the build script ceases to perform any additional ones of the series of operations if the one of the plurality of computing data resources is not available.

17. The automated software build system according to claim 13, wherein, responsive to one of the plurality of computing data resources being provided in the data definition without the allocation parameter, the build script ceases to perform any additional ones of the series of operations if the one of the plurality of computing data resources is not available.

18. The automated software build system according to claim 17, wherein, responsive to the build script ceasing to perform any additional ones of the series of operations, further generating an error message that corresponds to the one of the plurality of computing data resources that is unavailable.

19. The automated software build system according to claim 12, further comprising executing the build script by converting a plurality of source code files into a software file that is the software application by compiling and/or linking ones of the plurality of computing data resources in a given order.

20. A computer program product, comprising:
a non-transitory computer readable storage medium storing computer readable program code which when executed by a processor of an electronic device causes the processor to perform operations comprising:
providing a data definition corresponding to a software application build process for building a software application, the data definition including identities of a plurality of computing data resources in a build script that, when executed, performs a series of operations that use ones of the plurality of computing data resources to build the software application;
designating, in the build script, at least one of the plurality of computing data resources in the build script that is a conditionally allocated computing data resource; and
executing the build script by performing the series of operations that are identified therein using corresponding ones of the plurality of computing data resources that are identified in the data definition,
wherein responsive to the conditionally allocated computing data resource being unavailable, the build script continuing to perform other ones of the series of operations using other ones of the plurality of computing resources.
